(19) United States
(12) Patent Application Publication
(10) Pub. No.: US 2026/0243353 A1
(43) Pub. Date: Aug. 20, 2026

(54) Reduced Stroke Control Cartridge For Hydraulic Valve

(71) Applicant: GIACOMINI S.p.A., San Maurizio d'Opaglio (Novara) (IT)

(72) Inventors: Marco Rosa Brusin, San Maurizio d'Opaglio (Novara) (IT); Samuele Molina, San Maurizio d'Opaglio (Novara) (IT); Giuliano Ruga, San Maurizio d'Opaglio (Novara) (IT)

(21) Appl. No.: 19/153,634

(22) PCT Filed: Feb. 13, 2024
(86) PCT No.: PCT/IB2024/051332

§ 371 Date: Aug. 5, 2025

(30) Foreign Application Priority Data
Feb. 27, 2023 (IT) 102023000003516

(51) Int. Cl. F16K 3/26; F16K 27/04

(52) U.S. Cl. CPC F16K 3/267; F16K 27/041; F16K 2200/501

(57) ABSTRACT

A control cartridge assembly (10) for a valve (100) suitable to be motorised or actuated by an thermal head, comprises a cartridge body (12) within which a stem (14) is slidingly arranged, a linear shutter (16) attached to a first inner end of the stem (14) suitable for connection with a linear actuator to regulate the lift of the shutter (16), the cartridge body (12) comprises at least a first pass-through radial opening (13) formed on its diametral portion; and the shutter (16) comprises at least a second pass-through radial opening (18) formed on its diametral portion, the shutter (16) being coaxially and slidingly arranged in the cartridge body (10) in a telescopic manner such that an alignment in cooperation of the first radial opening (13) and the second radial opening (18) corresponds to a further opening for fluid passage.

### FIELD OF TECHNOLOGY

The present invention relates to a control cartridge for a hydraulic valve.

More particularly, the present invention relates to an insertable control cartridge assembly or bonnet with a linear shutter for a motorized hydraulic globe valve.

### STATE OF THE PRIOR ART

Well-known in the fields of plumbing and thermal heating/cooling systems are hydraulic valves for controlling the flow rate of a fluid, generally called globe valves, which are equipped with a discoidal or plate-shaped shutter actuated by a stem, which linearly translates open and close a fluid passage seat in the valve body. The control of the water flow rate depends on the passage area of the seat in the valve body and the lift of the shutter, which must generally counteract the passage pressure of the fluid to close the passage by making contact in the seat. The stem and main shutter are generally included in a regulating assembly or cartridge, also called “bonnet” that can be inserted into the valve body, which and may also include a pre-regulation system. Said regulating assembly or cartridge is typically operable by a servo-control arranged externally to the valve body. These types of valves can also be provided with means for balancing or compensating inlet pressures and are typically identified by the acronym PICV (Pressure Independent Control Valve) and are typically used for hydraulic applications in which the availability at the inlet of a constant flow rate of liquid, usually water, is sought, regardless of fluid pressure variations that may occur upstream and downstream.

Said well-known types of motorized valves can also comprise up to three control groups; a flow rate pre-regulation group suitable for pre-selecting a maximum nominal flow rate at the user inlet, a feedback control group, typically shutter type, suitable for controlling or biasing the required heat transfer fluid flow rate depending, for example, on the ambient temperature, and a balancing or compensation group suitable for maintaining a constant flow rate regardless of the pressure conditions upstream and downstream of the valve.

Motorized valves are typically controlled by an actuator, such as a well-known thermal head equipped with a pusher, capable of linearly actuating the stem that closes the disc shutter in the valve body by obstructing and closing the passage of fluid. Said actuator is typically realized by means of a mechanical or electromechanical device, advantageously connected to an electronic control unit and capable of closing the valve shutter, for example, depending on the ambient temperature. These types of valves are also typically provided with a pre-regulation system, operable by the user by means of a graduated knob, connected to a control sleeve provided with openings suitable for varying in rotation with the sleeve the cross-sectional area of fluid passage in such a way as to set the maximum required fluid flow rate corresponding, for example, to the maximum amount of thermal energy to be transmitted.

Examples of these types of valves are described in WO 2020/183258 (A1), on behalf of the same applicant, WO 2018/051150 (A1) and EP 3 067 772 (A).

A limitation and drawback to the operation of these mentioned types of valves is that standardized mass-produced valves having proportionally increasing sizes must be equipped with a corresponding linear actuator sized to provide the force to counteract the pressure and linear travel to close the main shutter. In large motorized valves designed to provide the largest fluid flow rates, the actuator must be proportionately larger in size as the valve size, flow rate, and fluid pressure of the valve increase, and must be able to provide proportionately greater force and greater actuator travel to allow the shutter to close by defeating the fluid pressure force. Generally, therefore, valves operating on higher flow rates and higher fluid operating pressures must be motorized with large actuators and thus with larger overall dimensions as well as expensive.

### OBJECTS OF THE INVENTION

The object of the present invention is to overcome and obviate, at least in part, the above-mentioned drawbacks and limitations in operation.

More particularly, one object of the present invention is to make available to the user a motorized hydraulic valve with a reduced stroke control cartridge capable of providing a smaller working stroke of the linear shutter and requiring, for the same hydraulic performance, less actuating force from the motorized linear actuator or coupled thermal head.

It is further the object of the present invention to make available a motorized hydraulic valve with a reduced stroke control cartridge having a high degree of reliability and durability, such, moreover, that it can be easily and economically fabricated.

It is also the object of the present invention to make available a cartridge regulating assembly for a hydraulic valve (e.g., PICV type) having a shutter with a reduced working stroke and capable of operating with actuators of reduced size and cost, as compared with known actuators, for the same amount of force required to ensure valve closure.

It is still a further object of the present invention to make available a cartridge-type regulating assembly for a hydraulic valve (e.g., of the PICV type) having a shutter with a reduced working stroke capable of allowing static-type pre-regulation of the amount of liquid flow through the valve.

It is an object of the present invention to provide a control cartridge assembly type with a linear reduced stroke shutter for a hydraulic valve, according to another aspect, it is an object of the invention to provide a motorized hydraulic valve provided with the reduced stroke shutter object of the present invention, in accordance with independent claims.

The constructional and functional features of the cartridge regulating assembly with a reduced stroke shutter and related motorized hydraulic valve which is the subject of the present invention may be better understood from the detailed description which follows, in which reference is made to the attached drawing plates representing some preferred and non-limiting embodiment, in which:

### BRIEF DESCRIPTION OF THE FIGURES

FIGS. 1 and 2 are a schematic representation of a longitudinal cross-sectional view of a motorized hydraulic valve in a simplified basic embodiment of the cartridge regulating assembly provided with the reduced stroke shutter which is the subject of the present invention, in the closed and open positions, respectively;

FIGS. 3 and 4 are a schematic representation of a longitudinal cross-sectional view of a motorized hydraulic valve in a further embodiment of the cartridge regulating assembly provided with the reduced-stroke shutter object of the present invention, in the closed and open positions, respectively, and with said cartridge body rotatable within the valve body 102 in cooperation with and with respect to said shutter in such a way as to increase or decrease the fluid passage cross-section for a pre-regulation of the maximum flow;

FIGS. 5 and 6 are a schematic representation of a longitudinal cross-sectional view of a motorized hydraulic valve in a further embodiment still of the cartridge regulating assembly provided with the reduced-stroke shutter which is the subject of the present invention, in the closed and open positions, respectively, and with a cartridge body rotatable within and in cooperation with the valve body 102 in a manner to increase or decrease the fluid passage section for a pre-regulation of maximum flow;

FIG. 7 is a schematic representation of an exploded axonometric view of a preferred embodiment of a PICV-type motorized hydraulic valve with the cartridge regulating assembly provided with the reduced stroke shutter which is the subject of the present invention;

FIG. 8 is a schematic representation of an exploded axonometric view of a preferred embodiment of the PCIV-type motorized hydraulic valve with the cartridge regulating assembly provided with the reduced-stroke shutter object of the present invention;

FIG. 9 is a schematic representation of a cross-sectional view of the preferred embodiment of the motorized hydraulic valve object of the present invention with the cartridge regulating assembly provided with the reduced stroke shutter;

FIGS. 10 and 11 are a schematic representation of longitudinal cross-sectional views of, respectively, a traditional globe valve with control cartridge assembly or bonnet and disc shutter, according to the known art (FIG. 10), and a hydraulic valve with control cartridge assembly bonnet with the reduced stroke shutter object of the present invention (FIG. 11).

### DETAILED DESCRIPTION OF THE INVENTION

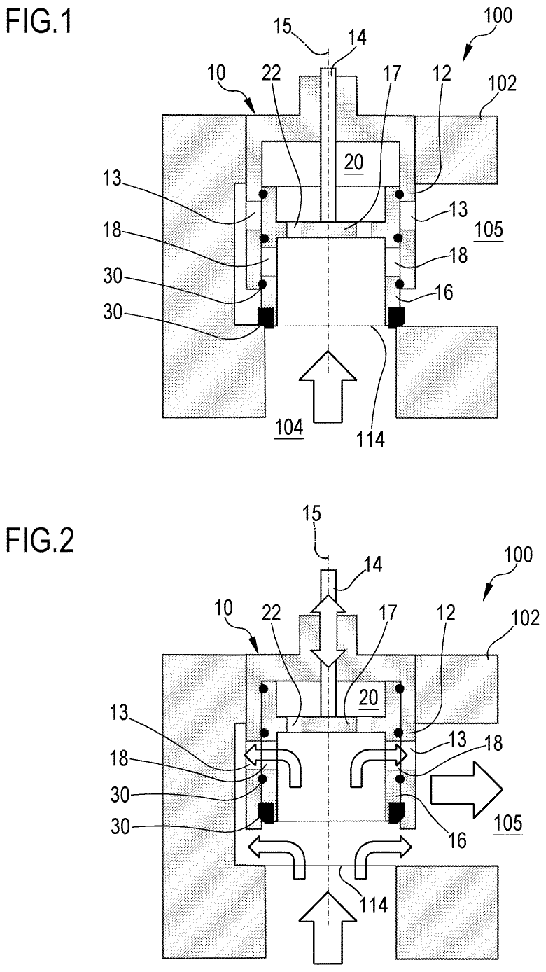

With initial reference to FIGS. 1 to 2, schematically shown in an essential embodiment is a valve 100 provided with a cartridge regulating assembly 10 according to the present invention.

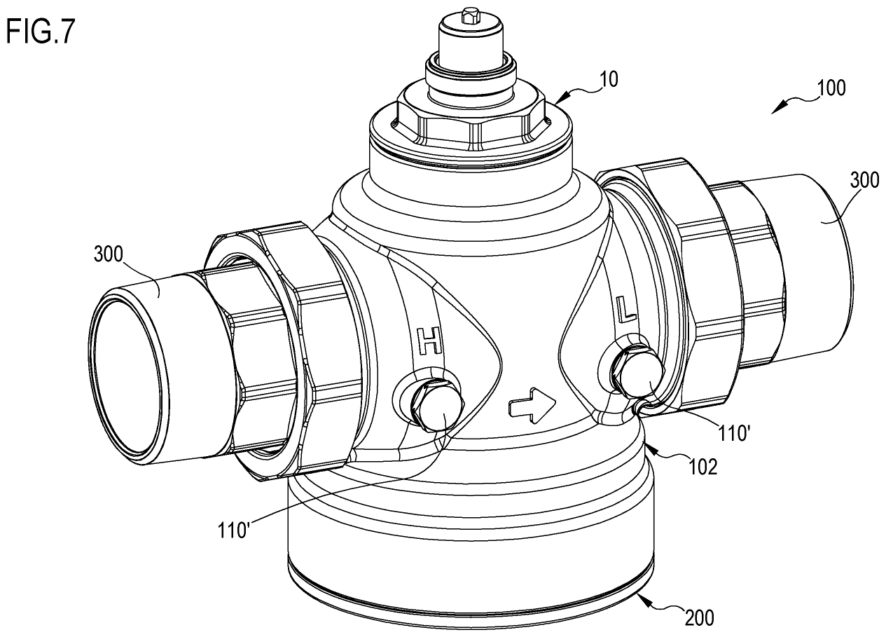

With particular reference also to FIGS. 7 to 9, in a preferred embodiment is shown the cartridge regulating assembly 10 configured to be connectable to and housed within a valve 100 and comprising a cartridge body 12, typically having a hollow cylindrical shape with an inverted socket with a perforated bottom within which a stem 14 is fluidly disposed.

In the various embodiments, with reference also to the other figures, the control cartridge assembly 10 comprises a shutter 16 linear coaxially and slidingly arranged with respect to said cartridge body 12 with respect to a longitudinal axis 15 and attached to a first internal stem end 14, adapted to be disposed internally to a valve 100, said shutter 16 being adapted to slide against said passage opening 114 of the valve body 102 in such a manner as to regulate the opening of a first area or span of passage of the shutter fluid through the valve 100 itself, from a maximum amount until it is completely blocked. A second end of stem 14 is exposed on the outside of valve body 100 and is apt to stand in connection with a conventional mechanical or electromechanical actuator or servomotor (not shown) intended for linear movement of stem 14 and shutter 16 in such a manner as to control the lift of the same.

Again with reference to the various embodiments of FIGS. 1 to 9, the cartridge regulating assembly 10 hereafter, more briefly, cartridge 10 includes the novel features of having a cartridge body 12 having a tubular socket shape inverted with respect to the axis 15, open to the passage opening 114, comprising at least a first radial opening 13 through, formed in its diametral portion, and having a shutter 16 having a hollow tubular shape comprising a central hub 17 drilled through suitable for connection with said inner end of said stem 14, said shutter 16 comprising at least a second through radial opening 18 formed in its diametral portion, and said shutter 16 being slidingly arranged telescopically in said cartridge body 12 so as to be able to define an additional fluid passage opening in the valve 100 and provide a greater fluid flow rate at the same working stroke of the shutter 16.

Said tubular-shaped shutter 16 may also advantageously define, in cooperation with said socket-shaped cartridge body 12, an airlock 20 configured to be placed in fluid connection with the valve interior 100 by means of at least one passage channel 22 formed in a substantially longitudinal direction in the central hub 17 of the shutter 16, in such a manner as to permit movement of the shutter with less force.

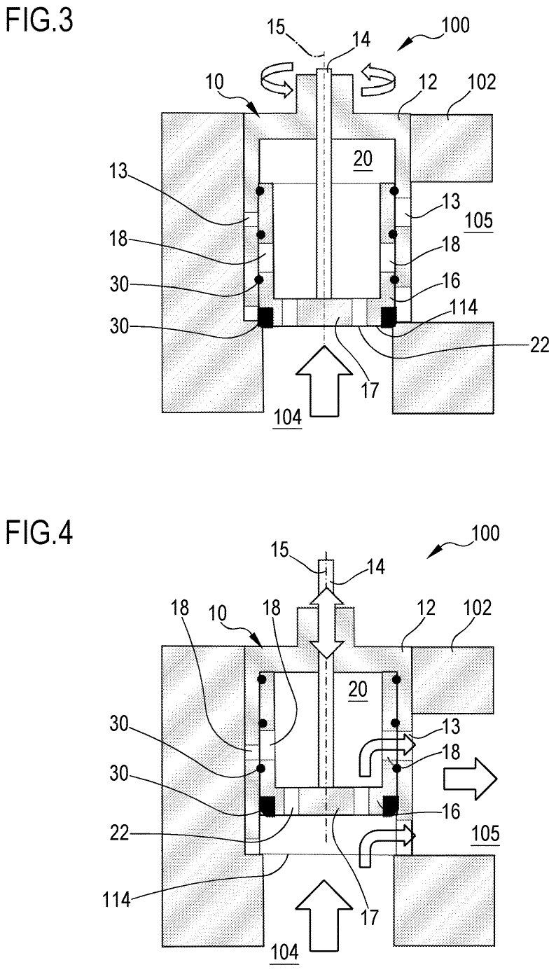

With particular reference to FIGS. 3 and 4, in a possible variant embodiment, said cartridge 10 may be advantageously and rotatably disposed within said valve body 102 about said longitudinal axis 15, and may comprise at least a first radial opening 13 of said cartridge body 12 in a hollow tubular or socket shape having a non-constant and variable cross-section along the diametrical circumference of said cartridge body 12, and may comprise at least a second radial opening 18 of said shutter 16, coaxially and slidingly disposed with respect to said cartridge body 12, said at least one first radial opening 13 and said at least one second radial opening 18 being capable of cooperatively configuring with each other, when aligned, a variable and configurable fluid passage area or cross-sectional area by means of an angular rotation with respect to the longitudinal axis 15 so as to be able to realize a pre-regulation of the maximum flow rate of fluid suitable to pass through the valve.

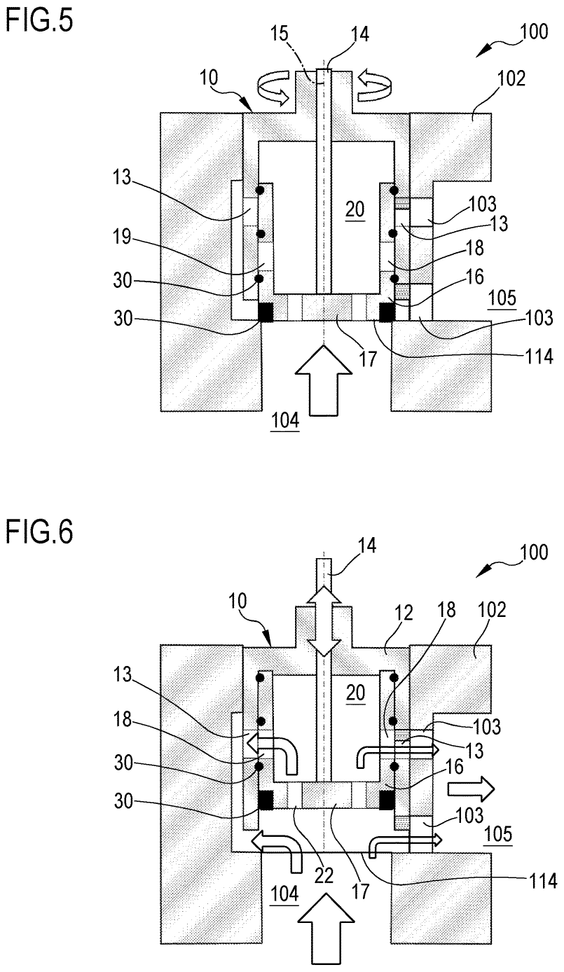

With particular reference also to FIGS. 5 and 6 in a further possible variant embodiment of valve 100, said cartridge 10 may be advantageously and rotatably arranged within said valve body 102, about said longitudinal axis 15, and being provided with a cartridge body 12 having a hollow or socket tubular shape comprising at least a first radial opening 13 having a non-constant and variable cross-section along the diametrical circumference of said cartridge body 12, and wherein said valve body may advantageously comprise a further inner wall 103 in which is recessed at least a third radial opening 103′ formed on a wall 103 of the valve body 102, said at least one first radial opening 13 and said at least one third radial opening 18 being suitable for cooperatively configuring with each other, when aligned, a variable and configurable fluid passage area or section by means of an angular rotation with respect to the longitudinal axis 15, so as to be able to realize a pre-regulation of the maximum flow rate of fluid apt to pass through the valve.

With special reference again to FIGS. 7 to 9, said control cartridge assembly 10 is adapted to be inserted into the valve body 102 at the operating opening 106 and held in place by traditional removable means of attachment 50, such as a threaded plug 50.

Referring again to the main embodiment of FIGS. 1, 2, 7 8 and 9, said first and second radial openings 13, 18 of the cartridge body 12 and shutter 16, are machined on the respective diametrical circumferences of the same in such a manner as to provide, when axially aligned in cooperation, a constant fluid passage opening regardless of their angular orientation with respect to the longitudinal axis of said cartridge body 12.

In further alternative variant embodiments, said shutter and said cartridge body may further comprise traditional means of keying one relative to the other such as shaped guides, notches or keys in such a way as to prevent axial rotation relative to each other. With particular reference to the embodiment of FIGS. 3 and 4 said cartridge body 12 and said shutter may also be further provided with angular adjustment means in such a manner that the angular position of the first radial openings of the shutter with respect to the second radial openings of the cartridge body with respect to the longitudinal axis can be gradually varied in such a manner that the cross-sectional area of fluid passage between the same first and second radial openings can be gradually varied.

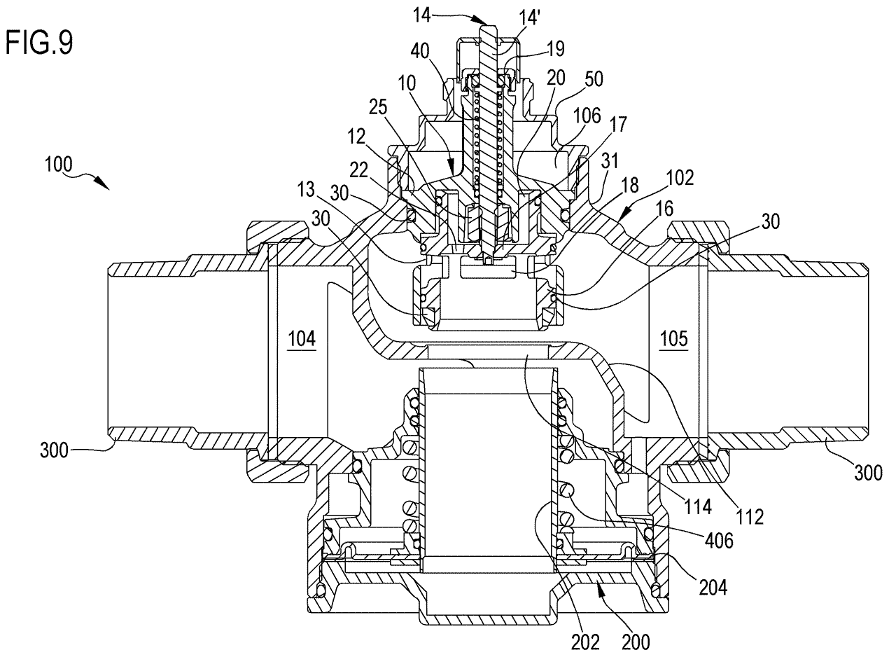

With particular reference to FIG. 9, said stem 14 may also be provided with an additional spring element 40, such as, for example, a conventional coil spring, coaxially arranged on the stem 14 and in the cartridge body 12 in such a way as to hold the stem 14 with the shutter 16 in a normally open monostable position relative to the opening 114 of the body 102 as shown in the preferred embodiment of the figures. Said stem 14 and said spring element 40 can typically be held in position in the cartridge body 12 by means of a ferrule 19.

Said tubular shutter 16 may also advantageously comprise radial fluidic sealing means 30, such as annular seals or O-rings, arranged on the diametral end of the shutter 16, apt to contact against the inner wall 112 of the valve body 102 in such a manner as to seal the passage opening 114, or arranged on the diametral portion of the same shutter before and after said at least a second radial opening 18 in such a manner as to prevent fluid leakage between the shutter 16 and the cartridge body 12. The cartridge body 12 may also advantageously comprise additional fluidic sealing means 31 with valve body 102, such as annular seals, O-rings, or watertight threads.

With special reference to FIGS. 7 to 9, it is shown in a preferred embodiment a PICV-type motorized hydraulic valve 100 according to the present invention. The valve 100 includes a valve body 102 having an inlet opening 104, an outlet opening 105, and a maneuvering opening 106 suitable for housing a cartridge assembly 10. An additional opening 108 in which a conventional dynamic pressure balancing or compensation assembly 200 may be connected or arranged may be further formed in the valve body 102, particularly in PICV-type valves.

With particular reference again to FIG. 9, said balancing assembly 200 comprising, typically, a tubular element 202 slidingly actuated by a flexible diaphragm 204 (e.g., of elastomeric material) sensitive to the fluid pressure at the inlet opening 104 on one face thereof and to the fluid pressure at the outlet opening 105 on an opposite face thereof in such a manner as to lead the tubular element 202 to increase or limit the flow of fluid into the valve as a function of the pressure differential Δp between the inlet opening 104 and the outlet opening 105. In addition, the balancing assembly 200 also typically includes a spring element 406 suitable for maintaining the tubular element 202 in a monostable position (e.g., opening).

With particular reference again to the preferred embodiment of FIG. 9, the control cartridge assembly 10 is configured such that said stem 14 may include a threaded portion at the connection end with the tubular shutter 16. Said stem 14 is rotatably disposed in the cartridge body 12 and free to rotate coupled to and in cooperation with of a threaded element 25 integral with the same cartridge body 12, so that a rotation of the stem 14 corresponds to an axial translation of the shutter 16 with respect to the cartridge body 12, in order to obtain a different alignment of the first and second radial openings 13, 18 and a greater or lesser distance of the shutter 16 from the axial passage opening 114, allowing an axial static pre-regulation of the maximum flow rate of fluid that can pass through the valve 100.

With particular reference to FIG. 2, said valve body 102 typically also includes one or more service openings 110 suitable for the maintenance and control of pressures within the valve 100 during commissioning; said service openings 110 are normally closed by plugs 110′.

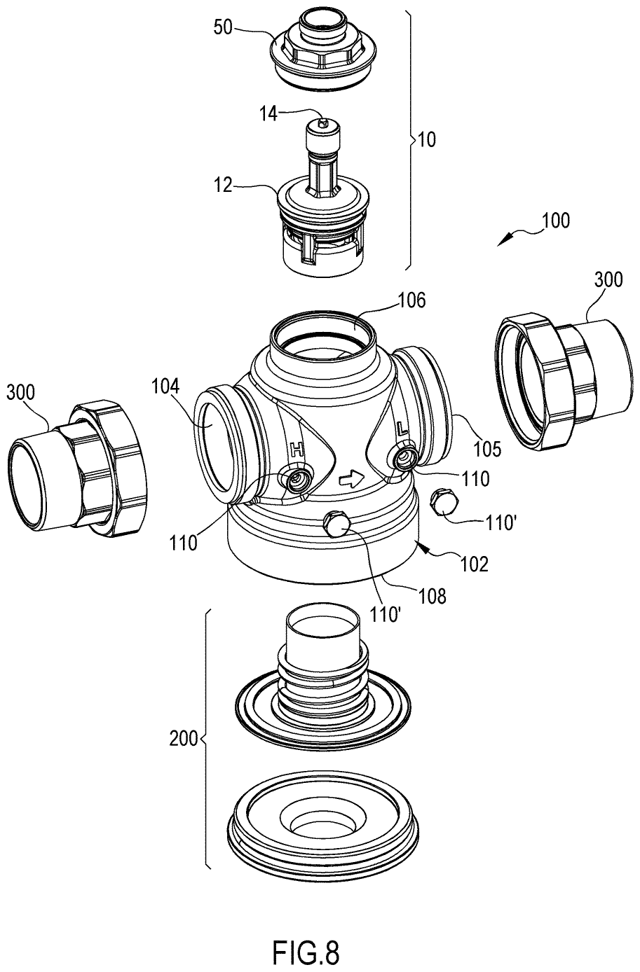

With particular reference to FIG. 8, valve 100 is provided with an inner wall 112 with a passage opening 114 over which a control cartridge assembly 10 and a balancing assembly 200, if any, operate.

The valve 100 may also generally be provided with conventional connecting fittings 300 arranged at the inlet and outlet openings 104 and 105.

From the description of the valve 100 and cartridge 10 above, the operation described below is apparent.

With initial reference to FIGS. 1 and 2, the cartridge 10 which is the subject of the present invention is adapted to be inserted into the valve body cl 102 by means of the conventional means 50 means of attachment and provides, in comparison with cartridge shutter assembly according to the known art a greater area of fluid passage with a smaller excursion of the shutter and a smaller stroke work to the lineal actuator acting on the free end 14′ of the stem 14, as shown in FIG. 9.

With special reference again to FIG. 9, in the rest position stem 14 is pushed by spring element 40 in such a way that it slides outward from valve 100. In the position of FIG. 3, the first fluid passage area between the inner wall 114 of the body 12 and the tubular shutter 16 is open and the fluid can flow freely from the inlet opening 104 to the outlet opening 105.

The even partial alignment in the coaxial telescopic translation movement of said at least one first radial opening 13 on the cartridge body 12 and of said at least one second radial opening 18 on the shutter 16 defines a second additional liquid passage area between the shutter 16 and the cartridge body 12.

When a linear actuator acts on the stem 14 pushing in such a way as to close the shutter 16 toward the inner wall 112 at the passage opening 114, the telescopic translation movement of the shutter 16 with respect to the cartridge body 12 progressively reduces both fluid passage areas until they close completely when the shutter 16 comes in contact with the inner wall 112 and the first and second radial openings 13 18 are longitudinally misaligned in the direction of travel of the shutter 16 being the first radial opening 13 closed by the outer diametrical surface of the shutter 16 and the second radial opening 18 by the inner diametrical surface of the cartridge body 12. The sealing means 30 guarantee less influence of liquid pressure and better fluidic sealing between the inlet opening 104 and the outlet opening 105 by preventing fluid leakage between the moving parts of the cartridge 10 and between the cartridge and the valve body 102.

Additional fluidic sealing means 31 (FIG. 9) also provide fluidic sealing and prevent leakage between cartridge 10 and valve body 102.

In addition to a larger fluid passage area, which can be achieved by a reduced excursion of the shutter 16 and thus a reduced working stroke of the linear actuator, the cartridge 10 and valve 100 also allow for less linear actuator strain thanks to the compensation chamber 20 defined between the hollow parts of the coaxially and smoothly arranged shutter 16 in the cartridge body 12.

Fluid pressure through the passage opening 114 normally acts against the surface of the central hub 17 of the shutter 16, facing the valve interior, resisting the closure of the shutter 16 itself.

The passage channel 22 allows the fluid to pass through the central hub 17 and fill the compensating chamber 20. The pressure generated by the fluid in the compensating chamber 20 on the surface of the central hub 17, facing outward from the valve, offsets the pressure of the incoming fluid acting on the opposite surface of the central hub, allowing the shutter to be moved with less force.

With reference to FIGS. 3 through 6, the cartridge 10 can also be advantageously rotatably arranged within the valve body 102 in such a way as to expose toward the outlet opening 105, the radial opening 13 with variable section along the circumference, by axial rotation of the cartridge body 12 along the longitudinal axis 15, in cooperation with the first openings 13 of the shutter 16 or as of the third radial openings 103′ formed on the wall 103 of the valve body 102 arranged at the outlet opening 105. The adjusted rotation about the longitudinal axis 15 of the cartridge body 12 with respect to the valve body 102 or of the shutter 16 with respect to the cartridge body allows static pre-regulation of the maximum flow rate of fluid that can pass through the valve 100.

With reference to FIG. 9, cartridge 10 can include a stem 14 advantageously threaded and arranged in a rotatable manner within cartridge body 12 such that it can rotate in cooperation with an element the threaded element 25, such as a threaded nut, integral with cartridge body 12. This configuration allows for axial controlment of the shutter 16 and thus the alignment of the second radial openings 18 with respect to the first radial openings 13 and the maximum excursion of the shutter 16 with respect to the outlet opening 114 thus advantageously allowing for static axial pre-regulation of the maximum flow rate of fluid that can pass through the valve 100.

In a further possible embodiment, not shown, also said cartridge body 12 can translate axially with respect to said valve body 102 in cooperation with said shutter 16 translating both with respect to the cartridge body, thus realizing a mechanism properly called telescopic in such a way as to maximize the opening and regulating effect of valve 100 while minimizing the excursion and working stroke of shutter 16 at the same fluid passage cross-section.

In a further possible embodiment, not shown, said cartridge body 12 can also translate axially with respect to said valve body 102 in cooperation with said shutter 16 which translates both with respect to the cartridge body, thus realizing a mechanism properly called telescopic in such a way as to maximize the opening and regulating effect of valve 100 while minimizing the excursion and working stroke of shutter 16 at the same fluid passage cross-section.

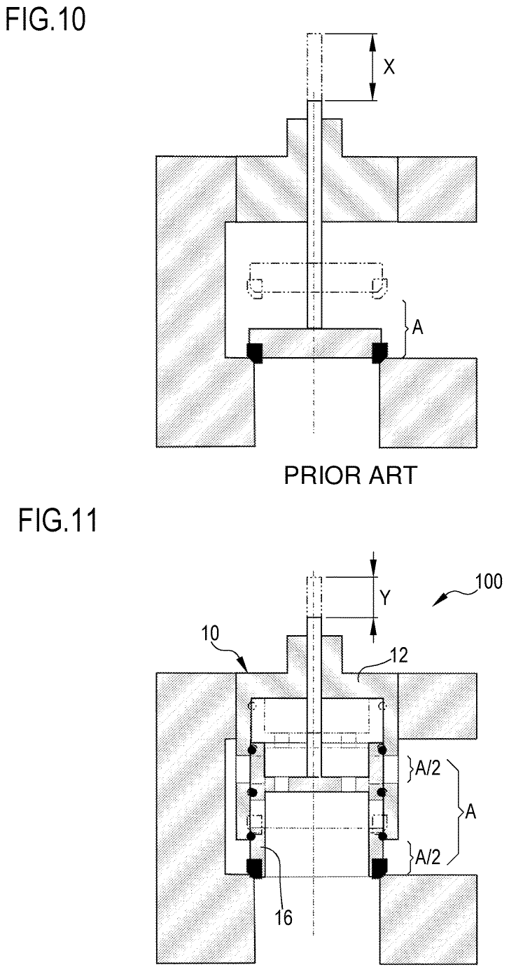

As can be seen from the foregoing, the advantages that the hydraulic valve 100 with reduced-stroke control cartridge 10 subject of the present invention achieves are obvious. The cartridge assembly 10 and the related hydraulic valve 100 are particularly advantageous, with particular reference to FIGS. 10 and 11, because they allow the user to have at the same liquid pressures and working flow rates a more compact valve with reduced overall dimensions due to a limited excursion y of the shutter 16 and thus a reduced size of the control cartridge assembly 10 compared to the excursion x of a traditional control assembly while keeping the passage area or section A of the valve 100 and the linear actuator unchanged.

Further advantage of valve 100 and cartridge assembly 10 is that of being able to employ, at the same working pressures and flow rates of valve 100, of a smaller linear actuator with a smaller working force and thus further compact and less expensive.

Although the invention has been described above with particular reference to a preferred embodiment, given for illustrative and non-limiting purposes, numerous modifications and variations will appear obvious to a skilled person in the art in light of the above description. The present invention, therefore, is intended to embrace all modifications and variations falling within the scope of protection of the following claims.

1. A control cartridge assembly (10) for a valve (100) configured to be motorised or actuated by a thermal head, comprising:
a cartridge body (12) within which a stem (14) is slidingly arranged, and
a linear shutter (16) fixed to a first inner end of said stem (14) which is configured for being connected to a linear actuator in such a manner as to regulate the lift of said shutter (16) and configured for regulating a first passage fluid area of the valve (100);
wherein said cartridge body (12) has a cup shape and comprises at least a first radial opening (13) formed on a diametral portion thereof and that said shutter (16) has a hollow shape and comprises a drilled through central hub (17) for connection with said inner end of the stem (14) and comprises at least a pass-through second radial opening (18) in said diametral portion thereof, said shutter (16) being coaxially and slidingly arranged with respect to said cartridge body (12) in a telescopic manner so that upon an alignment in cooperation of said first radial opening (13) and said second radial opening (18) defines a further fluid passage opening.

2. The control cartridge assembly (10) according to claim 1, wherein said shutter (16) defines, in cooperation with said cartridge body (12), a compensation chamber (20) configured to be placed in fluid connection by at least one passage channel (22) formed in a longitudinal direction in said central hub (17) of said shutter (16).

3. The control cartridge assembly (10) according to claim 1, configured to be rotatably arranged within a valve body (102) about a said longitudinal axis (15), wherein said first radial opening (13) of said cartridge body (12) has a variable cross-section along the diametral circumference of said cartridge body (12) and defines when aligned in cooperation with said second radial opening (18) of said shutter (16) a configurable variable fluid passage area or cross-section by means of an angular rotation with respect to said longitudinal axis (15) in such a manner to realise a pre-regulation of the maximum fluid flow rate suitable to pass through said valve (100).

4. The cartridge regulating assembly (10) according to claim 1, configured to be rotatably arranged within a valve body (102) about a longitudinal axis (15), wherein said first radial opening (13) of said cartridge body (12) has a cross-sectional area and variable along the diametrical circumference of said cartridge body (12), said first radial opening (13) being configured to define in cooperation with a third radial opening (103′) of an inner wall (103) of said valve body (102), when aligned, a variable fluid passage area or cross-section configurable by means of an angular rotation with respect to said longitudinal axis (15), so as to be able to realize a pre-regulation of the maximum fluid flow rate suitable to pass through said valve (100).

5. The control cartridge assembly (10) according to claim 1, wherein said stem (14) comprises an elastic element (40), coaxially disposed between said stem (14) and said cartridge body (12).

6. The control cartridge assembly (10) according to claim 1, wherein said stem (14) comprises a threaded portion at a connection end with said shutter (16), said stem (14) being rotatably disposed in the cartridge body (12) coupled in cooperation with a threaded element (25) integral with said cartridge body (12), in such a manner to, in response to a rotation of the stem (14), corresponds to an axial translation of the shutter (16) with respect to the cartridge body (12).

7. The cartridge regulation assembly (10) according to claim 1, wherein said stem (14) and said spring element (40) are held in position in the cartridge body (12) by a ring nut (19).

8. The control cartridge assembly (10) according to claim 1, wherein said shutter (16) comprises fluidic sealing means (30), including annular seals or O-rings, arranged on the diametral end of the shutter (16) and arranged on the diametral portion of said shutter (16) before and after said at least one second radial opening (18), in such a manner as to prevent fluid leakage between said shutter (16) and said cartridge body (12).

9. The control cartridge assembly (10) according to claim 1, wherein said cartridge body (12) comprises fluidic sealing means (31) with said valve body (102), including annular seals, O-rings or watertight threads.

10. The control cartridge assembly (10) according to claim 1, comprising removable fixing means (50) for fixing to the valve body (102) of the valve (100).

11. A motorizable hydraulic valve (100) comprising:
a valve body (102) having an inlet opening (104), an outlet opening (105), a manoeuvring opening (106) and comprising an inner wall (112) with a passage opening (114); and
a cartridge regulating assembly (10) comprising:
a cartridge body (12) within which a stem (14) is slidingly arranged, and
a linear shutter (16) fixed to a first inner end of said stem (14) which is configured for being connected to a linear actuator in such a manner as to regulate the lift of said shutter (16) and configured for being capable of regulating a first passage fluid area of the valve (100);
wherein said cartridge body (12) has a cup shape and comprises at least a first radial opening (13) formed on a its diametral portion thereof and that said shutter (16) has a hollow shape and comprises a drilled through central hub (17) for connection with said inner end of the stem (14) and comprises at least a pass-through second radial opening (18) in said diametral portion thereof, said shutter (16) being coaxially and slidingly arranged with respect to said cartridge body (12) in a telescopic manner so that upon an alignment in cooperation of said first radial opening (13) and said second radial opening (18) defines a further fluid passage opening,
wherein said cartridge regulating assembly (10) is arranged in said manoeuvring opening (106) and configured to operating on said passage opening (114).

12. The hydraulic valve (100) according to claim 11, comprising a further opening (108) in said valve body (102) and a balancing or dynamic pressure compensation assembly (200) is arranged in the further opening (108).
